(19) United States
(12) Patent Application Publication
(10) Pub. No.: US 2005/0009997 A1
(43) Pub. Date: Jan. 13, 2005

(54) Novel chiral auxiliary bearing resins

(75) Inventors: Claude Spino, Sherbrooke (CA); Christian Nadeau, Saint-Laurent (CA); Vitthal Genbhau Gund, Numbai (IN)

Correspondence Address: FULBRIGHT & JAWORSKI L.L.P., 600 CONGRESS AVE., SUITE 2400, AUSTIN, TX, 78701, US

(73) Assignee: Universite de Sherbrooke

(21) Appl. No.: 10/730,486

(22) Filed: Dec. 8, 2003

(30) Foreign Application Priority Data
Dec. 6, 2002 (CA) 2,413,713

(51) Int. Cl. C08F 18/20

(52) U.S. Cl. 525/333.3; 526/246

(57) ABSTRACT

The present invention relates to chiral resins comprising the formula: 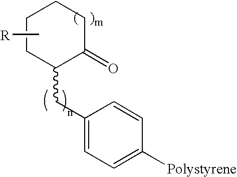
wherein R is selected from the group consisting of H, C₁-C₆ alkyl and C₁-C₆ branched alkyl; “n” represents an integer ranging from 1 to 3; and wherein “m” represents an integer ranging from 0 to 3.

### BACKGROUND OF THE INVENTION

This application claims the benefit of Canadian Application No. 2,413,713, filed Dec. 6, 2002. The entire text of the above Canadian application is specifically incorporated by reference.

A. Field of Invention

The present invention relates to novel chiral auxiliary bearing resins. More specifically, the present invention relates to novel chiral auxiliary bearing resins for the synthesis of small chiral organic molecules. Additionally, the present invention relates to methods of preparing the chiral resins as well as small chiral organic molecules.

B. Background of the Invention

Solid phase synthesis is a methodology whereby synthetic transformations are conducted with one of the reactant molecules attached to an insoluble material, commonly referred to as a solid support. Solid phase synthesis was originally developed for peptide synthesis and then for oligonucleotide synthesis. Ever since the emergence and impact of combinatorial chemistry have solid phase techniques been applied more generally to organic chemistry.

Merrifield was the first to use the term “solid phase peptide synthesis”, to describe the preparation of a peptide on a polymer which remained insoluble throughout the synthesis (Merrifield, 1963).

One of the primary reasons for the development of solid phase methodology was to overcome the technical difficulties associated with the solubility and purification of growing peptide chains in solution. On solid phase, purification is simply achieved by washing the resin in a variety of solvents, thus dissolving and subsequently washing away any unbound impurities. Furthermore, solid supports allow for the use of excess amounts of solution phase reagents since they can be easily removed. This implies that reactions can often be driven to completion to provide higher yields in comparison to the corresponding solution phase reactions.

The recent advent of high throughput automated techniques has facilitated the screening of very large numbers of compounds. This, combined with the increasing number of therapeutic target proteins emerging from molecular biology and genome sequencing, has generated a need to rapidly and efficiently synthesize large collections of diverse molecules for screening. Combinatorial chemistry, wherein compounds are systematically assembled by combining a collection of building blocks using synthetic and biosynthetic techniques, addressed the need to quickly and efficiently prepare thousands of compounds, called “libraries”. It is the number and variety of structures that libraries can offer that are their attraction. They may be designed to be structurally biased to a known pharmacophore with the intention of maximizing biological activity. Alternatively, any structural preconception of what might, or should have affinity for the target, can be discarded in favor of the discovery of a novel lead. The goal of combinatorial synthesis is thus to simultaneously produce many different products related by a structure type.

Solid supports require a linker to connect the target molecule to the support. In many ways, linkers bear many similarities to the protecting groups of solution phase chemistry, and many of the early linkers were developed by analogy to these. One of the first linkers to emerge for the immobilization of carboxylic acids was based on the benzyl alcohol protecting group. Further linkers evolved from the o-nitrobenzyl protecting group. An acyl sulfonamide linker was developed for peptide synthesis. Further examples include resins derivatized with the benzyloxycarbonyl protective group, which are suitable for the immobilization of primary amines, as well as linkers based on the THP group, which may be used for the immobilization of alcohols, phenols, purines and tetrazoles. Indeed, in the last 10 years a wide variety of linkers has been developed and most functionalities can be immobilized on solid phase. Traceless linkers, most of which are based on silicon chemistry, have also been developed. In traceless cleavage, a functional group is excised leaving behind no trace or “memory” of the solid phase synthesis.

Recyclable linkers have also been developed and involve a linker that can be regenerated upon substrate release, thus allowing for another synthetic cycle to begin on the same resin. Recyclable resins improve cost efficiency, particularly when involving large scale solid phase organic synthesis, involving repeated synthetic cycles.

Chiral resins inducing stereoselectivity have also been developed and include a linker incorporating a chiral auxiliary. Ideally, such systems are recyclable which implies that the chiral linker can be recycled at the end of the synthetic cycle. One of the first chiral resins made use of a 1,2-o-cyclohexylidene-α-D-xylofuranose as the chiral auxiliary (Kawana and Emoto, 1972). Coupling of (S)-2-phthalamido-1-propanol to Merrifield resin followed by treatment with hydrazine provided a chiral polymer bound amine (Worster et al., 1979). A C2 symmetric chiral pyrrolidone-based auxiliary has also been exploited in connection with chiral resins (Moon et al., 1994). Yet another example of a chiral resin constitutes the polymer supported Evans' oxazolidinone (Allin and Shuttleworth, 1996).

There thus remains a need to develop reusable chiral resins allowing for the rapid and cost efficient elaboration of chiral compound libraries, and methods of preparing the chiral resin.

The present invention seeks to meet these and other needs.

The present description refers to a number of documents, the contents of which are herein incorporated by reference in their entirety.

### SUMMARY OF THE INVENTION

The present invention relates to polymer resins bearing a chiral auxiliary, as well as to methods for preparing the chiral resins. More specifically, the present invention relates to a chiral resin represented by the following formula: 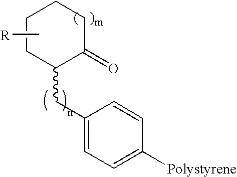
wherein R is selected from the group consisting of H, C1-C6 alkyl and C1-C6 branched alkyl; “n” represents an integer ranging from 1 to 3; and wherein “m” represents an integer ranging from 0 to 3.

The present invention also relates to a method for the synthesis of chiral compound libraries comprising:

(a) reacting a vinyl iodide of formula: 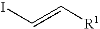
wherein R1 is selected from the group consisting of hydrogen, C1-C6 alkyl, C2-C6 alkenyl, C2-C6 alkynyl, C3-C6 cycloalkyl, alkylaryl, and alkyl silyl ether,
with a chiral resin of formula: 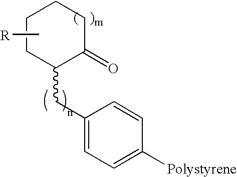
to provide an allylic alcohol of formula:

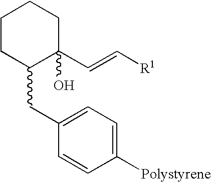

(b) transforming the allylic alcohol into an alkene of formula: 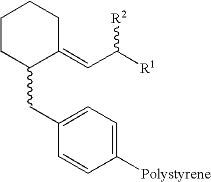
comprising reacting the allylic alcohol with an organocuprate of formula (R2)2CuLi, wherein R2 is selected from the group consisting of C1-C6 alkyl, branched C1-C6 alkyl, and phenyl; and

(c) oxidizing the alkene.

Furthermore, the present invention relates to the use of the chiral resins for the cost-efficient construction of chiral compound libraries. More specifically, the present invention relates to the use of the chiral resins in the preparation of chiral acetic acids, chiral aldehydes as well as chiral primary alcohols.

Finally, the present invention relates to chiral resins that can be recovered and re-used following completion of a reaction cycle.

Further scope and applicability will become apparent from the detailed description given herein after. It should be understood however, that this detailed description, while indicating preferred embodiments of the invention, is given by way of illustration only, since various changes and modifications within the spirit and scope of the invention will become apparent to those skilled in the art.

### DETAILED DESCRIPTION OF THE INVENTION

Unless defined otherwise, the scientific and technological terms and nomenclature used herein have the same meaning as commonly understood by a person of ordinary skill. Generally, procedures such as extraction, precipitation, and recrystallization are common methods used in the art. Such standard techniques can be found in reference manuals such as for example Gordon and Ford (The Chemist's Companion, 1972).

The present description refers to a number of routinely used chemical terms. Nevertheless, definitions of selected terms are provided for clarity and consistency.

Compounds that have the same molecular formula but differ in the nature or sequence of bonding of their atoms or the arrangement of their atoms in space are termed “isomers”. Isomers that differ in the arrangement of their atoms in space are termed “stereoisomers”. Stereoisomers that are not mirror images of one another are termed “diastereomers” and those that are non-superimposable mirror images of each other are termed “enantiomers”. When a compound has an asymmetric center, for example an atom that is bonded to four different groups or atoms, a pair of enantiomers is possible. An enantiomer can be characterized by the absolute configuration of its asymmetric center and is described by the R- and S-sequencing rules of Cahn and Prelog, or by the manner in which the molecule rotates plane polarized light designated as dextrorotatory or levorotatory (i.e. as (+) or (−)-isomers respectively). A chiral compound can exist as either individual enantiomer or as a mixture thereof. A mixture containing equal proportions of the enantiomer is called a “racemic mixture”.

As used herein, the expression “protecting group” refers to a chemical group that exhibits the following characteristics: 1) reacts selectively with the desired functionality in good yield to give a protected substrate that is stable to the projected reactions for which protection is desired; 2) is selectively removable from the protected substrate to yield the desired functionality; and 3) is removable by reagents compatible with the other functional group(s) present or generated in such projected reactions. Examples of protecting groups can be found in Green and Wuts (1991).

As used herein, the expression “dummy ligands” refers to non-transferable cuprate ligands, more specifically ligands that will not transfer to a substrate during cuprate additions.

In a broad sense, the present invention relates to novel chiral resins to be used in the construction of libraries of small chiral organic molecules as well as to methods of preparing the chiral resins. The libraries of small chiral organic molecules produced by the chiral resins of the present invention can be used, for example in the pharmaceutical field, in the search and development of new therapeutic compounds.

The chiral resins of the present invention are useful for the preparation of chiral carboxylic acids, including α-amino acids, β-amino acids, and α-hydroxy acids, as well as aldehydes and primary alcohols, in high yield and optical purity. The small chiral organic molecules produced using the chiral resins of the present application, may further comprise bulky substituents such as for example a tert-butyl group.

The chiral resins of the present application are broadly characterized by a resin-immobilized chiral cycloalkanone as illustrated by the following formula:

Polystyrene 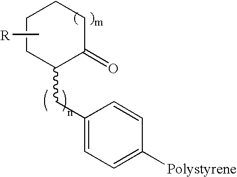
wherein R is selected from the group consisting of H, C1-C6 alkyl and C1-C6 branched alkyl; “n” represents an integer ranging from 1 to 3; and wherein “m” represents an integer ranging from 0 to 3.

In a preferred embodiment of the present invention, the chiral resin has the following formula:

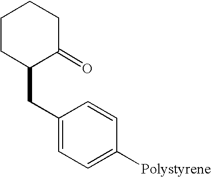

In a further preferred embodiment of the present invention, the chiral resin has the following formula:

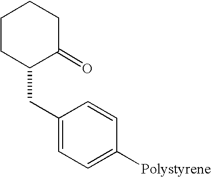

Additional examples of chiral resins as contemplated by the present invention include, but are not limited to:

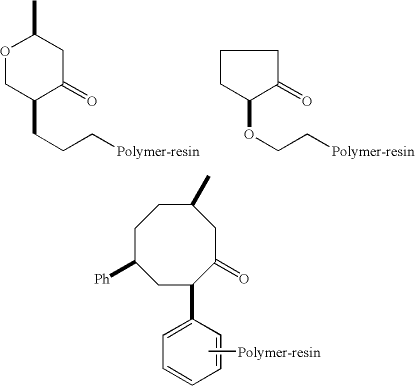

The preparation of chiral resins 1 and 2 is described by the reaction sequence illustrated below in Scheme 1. The synthesis of chiral resins 1 and 2 proceeds via chiral cyclohexanones 3 and 4 respectively, which can be prepared via the enantioselective alkylation of a chiral non-racemic lithioenamine (Meyers et al., 1981).

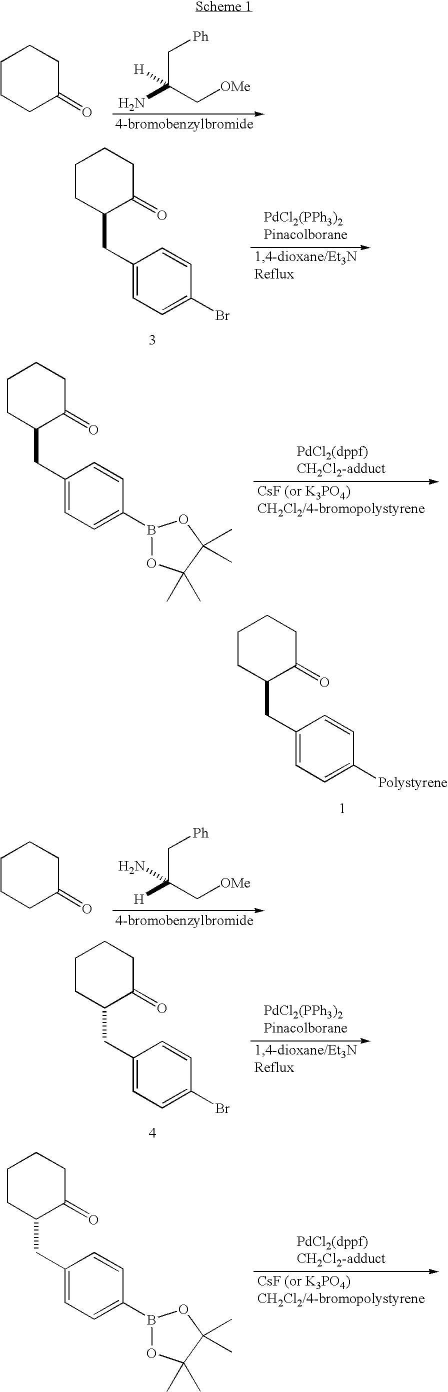

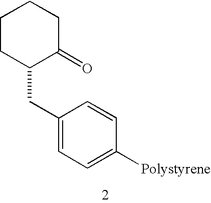

Each of the resins as prepared in Scheme 1, can be reacted following the reaction sequence illustrated below in Scheme 2 using chiral resin 1.

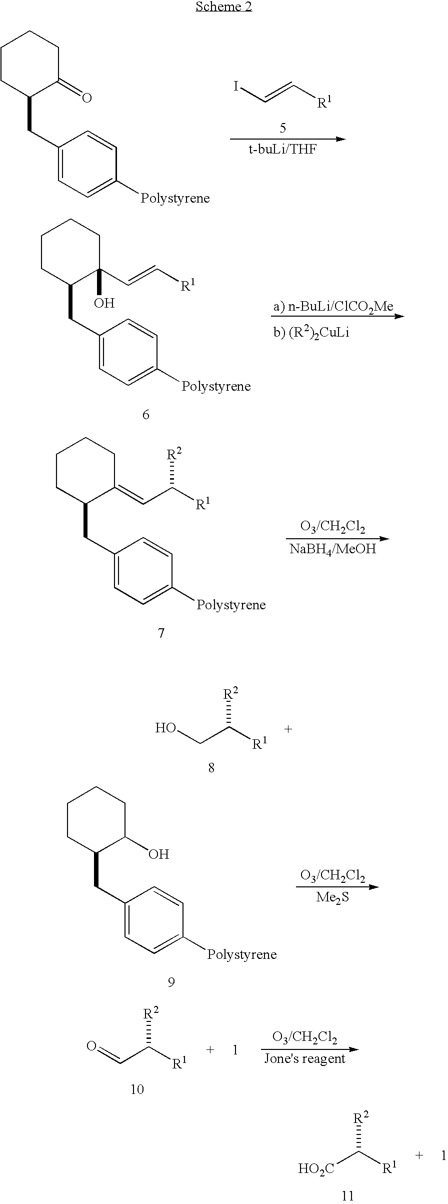

The first step in the above described reaction sequence involves the transmetallation of vinyl iodide 5, followed by its subsequent stereoselective addition to chiral resin 1, providing allylic alcohol 6. Transformation of allylic alcohol 6 into the corresponding carbonate using a chloroformate, followed by the stereoselective addition of a cuprate, provides substrate 7. Ozonolysis of substrate 7 can either produce chiral alcohol 8, chiral aldehyde 10 or chiral acid 11, depending on the reaction conditions. A reductive work-up using sodium borohydride generates chiral alcohol 8, in addition to chiral resin 9, which can be easily oxidized to regenerate chiral resin 1. A reductive work-up using dimethyl sulfide decomposes the ozonide to provide chiral aldehyde 10, whereas an oxidative work-up decomposes the ozonide to provide chiral acid 11. In both cases chiral resin 1 is regenerated in the process.

Any type of vinyl iodide compatible with the reaction conditions can be used in the above described reaction sequence. More specifically, any vinyl iodide comprising heteroatoms such as for example nitrogen, oxygen, sulfur, phosphorus and selenium, any of the halogens, or any other functional group can be used, with the provision that these heteroatoms, halogens or functional groups do not interfere with the transmetallation reaction. Furthermore, any type of cuprate, whether of lower or higher order, bearing dummy ligands such as for example thiophene, cyanide, t-butyl or —CH2SiMe3, or not, can be used in the above described reaction sequence.

Some representative examples of some of the chiral alcohols and aldehydes obtained following the reaction sequence illustrated in Scheme 3, are depicted below in Table 1.

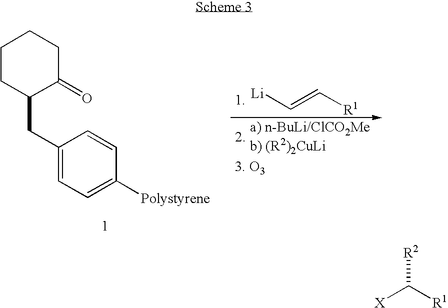

TABLE 1
Examples of various chiral alcohols and
aldehydes obtained with chiral resin 1

| Entry | R¹ | R² | X | Overall yield |
|---|---|---|---|---|
| 1 | CH₂CH₂Ph (5a) | Me | CH₂OH | 7.6 |
| 2 | CH₂CH₂Ph (5a) | Me | CHO | 5.6 |
| 3 | CH₂CH₂Ph (5a) | Ph | CH₂OH | 19.1 |
| 4 | CH₂CH₂Ph (5a) | Ph | CHO | 6.9 |
| 5 | CH₂CH₂Ph (5a) | n-Bu | CH₂OH | 4.0 |
| 6 | CH₂CH₂Ph (5a) | i-Bu | CH₂OH | 9.1 |
| 7 | CH₂CH₂Ph (5a) | i-Bu | CHO | 8.3 |
| 8 | CH₂CH₂Ph (5a) | t-Bu | CH₂OH | 3.3 |
| 9 | CH₂CH₂Ph (5a) | t-Bu | CHO | 9.1 |
| 10 | CH₂CH₂OSiMe₂t-Bu (5b) | Me | CH₂OH | 7.6 |
| 11 | CH₂CH₂OSiMe₂t-Bu (5b) | Me | CHO | 4.1 |
| 12 | CH₂CH₂OSiMe₂t-Bu (5b) | Me | CO₂H | 3.5 |
| 13 | CH₂CH₂OSiMe₂t-Bu (5b) | Ph | CH₂OH | 4.3 |
| 14 | CH₂CH₂OSiMe₂t-Bu (5b) | Ph | CHO | 8.4 |
| 15 | CH₂CH₂OSiMe₂t-Bu (5b) | n-Bu | CH₂OH | 4.3 |
| 16 | CH₂CH₂OSiMe₂t-Bu (5b) | i-Bu | CH₂OH | 3.4 |
| 17 | CH₂CH₂OSiMe₂t-Bu (5b) | i-Bu | CHO | 4.1 |
| 18 | CH₂CH₂Me (5c) | Me | CH₂OH | 4.9 |
| 19 | CH₂CH₂Me (5c) | Me | CHO | 5.6 |
| 20 | CH₂CH₂Me (5c) | Ph | CH₂OH | 5.6 |
| 21 | CH₂CH₂Me (5c) | Ph | CHO | 15.9 |
| 22 | CH₂CH₂Me (5c) | i-Bu | CH₂OH | 5.7 |
| 23 | CH₂CH₂Me (5c) | i-Bu | CHO | 4.5 |

The use of the chiral resins of the present application, allows for the preparation of chiral acetic acids, chiral aldehydes as well as chiral primary alcohols in higher optical purity as compared to the classical methods involving the alkylation of chiral enolates (Arya and Qin, 2000). Additionally, the chiral resins of the present application allow for the preparation of chiral acids, aldehydes and primary alcohols comprising bulky substituents such as for example tert-butyl and phenyl groups, otherwise difficult to prepare. Further, the use of the chiral resins of the present application is cost efficient and provides for the recovery and re-use of the resins upon completion of the reaction sequence.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Preparation of Resin 1

2-(4-Bromobenzyl)-cyclohexanone (3)

Compound 3 was prepared from cyclohexanone in three steps in 65% overall yield, using (S)-phenylalanine as the chiral auxiliary for the alkylation step.

¹H NMR (CDCl₃, 300 MHz): 7.38 (2H, d, J=8.15 Hz), 7.03 (2H, d, J=8.79 Hz), 3.15 (1H, dd, J=4.95 & 13.75 Hz), 2.55-2.25 (4H, m), 2.1 (2H, m), 1.85 (1H, m), 1.6 (2H, m), 1.3 (1H, m).

¹³C NMR (CDCl₃, 300 MHz): 139.36(s), 131.28(d), 130.89(d), 119.7(s), 52.27(d), 42.12(t), 34.88(t), 33.45(t), 27.95(t), 25.05(t).

HRMS: Calculated: 266.0306, found: 266.0301.

LRMS: 266,268 (M⁺), 237,239, 209,211, 182,184, 169,171 (base peak).

2-[4-(4,4,5,5-tetramethyl-[1,3,2]dioxaborolan-2-yl)-benzyl]-cyclohexanone

To a stirred solution of aryl bromide 3 (0.6 g, 0.002247 moles) in anhydrous 1,4-dioxane (8 ml), under an argon atmosphere was added the dichlorobis(triphenylphosphine) palladium (II) (0.0788 g, 0.0001123 moles) catalyst. The reaction mixture was then stirred at room temperature for 15 minutes. Anhydrous triethyl amine (0.682 g; 0.939 ml, 0.00674 moles), followed by pinacolborolane (0.431 g; 0.489 ml, 0.00337 moles) was then added to the reaction mixture. The reaction mixture was then heated at 80-100° C. over a 1 hour period. After cooling the reaction mixture to ambient, the dioxane solvent was concentrated under vacuum and poured into water (50ml), followed by extraction with diethyl ether (3×15 ml). The combined ether layers were washed with water and brine, dried over MgSO₄, filtered and concentrated under vacuum to provide the crude boronate ester, which was subsequently purified using flash chromatography over silica gel using 5-15% ethyl acetate/hexane as a gradient eluent to provide the desired product as a low melting white solid (0.376 g, 67%). Some dehalogenated product was also obtained (0.072 g, 17%).

¹H NMR (CDCl₃, 300 MHz): 7.71 (2H, d, J=7.69 Hz), 7.15 (2H, d, J=7.69 Hz), 3.23 (1H, dd, J=4.4 & 13.75 Hz), 2.55-2.25 (4H, m), 2.0 (2H, m), 1.8-1.5 (4H, m), 1.32 (12H, s).

¹³C NMR CDCl₃, 300 MHz): 212.09 (s), 143.7 (s), 134.64 (d), 128.43 (d), 83.47 (s), 52.15 (d), 41.93 (t), 35.52 (t), 33.19 (t), 27.82 (t), 24.91 (t), 24.72 (q).

HRMS: Calculated: 314.2053, found: 314.2063.

LRMS: 314 (M⁺, base peak), 295, 271, 217;

GCMS of the crude product obtained using the PdCl₂(PPh₃)₂ catalyst showed a 84:16 ratio of boronate ester: dehalogenated compound, whereas with the PdCl₂(dppf).CH₂Cl₂ catalyst the ratio of boronate ester: dehalogenated compound was 83.81:16.18.

Use of the PdCl₂(PPh₃)₂ catalyst or the PdCl₂(dppf).CH₂Cl₂ catalyst provided for essentially the same ratio of boronate ester to dehalogenated compound. However, the time required to complete the reaction using the PdCl₂(PPh₃)₂ catalyst was from about 1 to 3 hours, whereas the PdCl₂(dppf).CH₂Cl₂ catalyst required in excess of 15 hours.

tert-Butyl-(4-iodo-but-3-enyloxy)-dimethylsilane (5b)

To a cooled (0-5° C.) solution of 3-butyne-1-ol (15 g; 16.198 ml; 0.2140 moles) in dry dichloromethane (215ml) was slowly added imidazole (36.42 g, 0.535 moles) under an argon atmosphere, and the clear solution was stirred for 15 minutes. tert-Butyldimethylsilylchloride (48.386 g, 0.321 moles) was slowly added in lots while keeping the solution at 0-5° C. The reaction mixture was continued to be stirred at the same temperature for an additional 1.5 hours, followed by 15 hours at room temperature. The reaction mixture was poured into water (500 ml) and the dichloromethane layer separated. The aqueous phase was extracted with dichloromethane (2×100 ml) and the combined organic layers were washed with water and brine. They were then dried over anhydrous magnesium sulfate, filtered and concentrated under vacuum. Distillation of the crude reaction mixture provided pure tert-butyldimethylsilyl protected 3-butyne-1-ol as colorless liquid (38.95 g, 98.93%).

¹H NMR (CDCl₃, 300 MHz): 3.74 (2H, t, J=7.14 Hz), 2.4 (2H, m), 1.95 (1H, t), 0.89 (9H, s), 0.074 (6H, s).

HRMS: MF=C₉H₁₇OSi (M-CH₃), calculated: 169.1049, found: 169.1046.

LRMS: 169 (M-CH₃), 127 (M-C₄H₉=base peak).

To a stirred solution of bis(cyclopentadienyl)zirconium dichloride (9.53 g, 0.0326 moles) in dry THF (116 ml) at 0-5° C., was slowly added lithium triethylborohydride (Super-hydride®) (32.6 ml, 1.0 M solution in THF) over a period of 20 minutes while under an argon atmosphere. The reaction mixture was then removed from the cooling bath and was continued to be stirred at room temperature for an additional hour. A solution of the tert-butyldimethylsilyl protected 3-butyne-1-ol (3 g, 0.0163 moles) in dry THF (14 ml) was slowly added to the reaction mixture at room temperature over a period of 10 minutes, followed by continued stirring for an additional hour. Iodine (9.103 g, 0.0358 moles) in dry THF (15 ml) was then slowly added at room temperature and the reaction mixture was continued to be stirred for an additional 15 hours. (Note: during all of these operations, the reaction flask was covered with aluminum foil to protect the reaction mixture from light).

The reaction mixture was poured into an aqueous saturated NaHCO₃ solution (300 ml) and was extracted in ether (3×75 ml). The combined organic layers were washed with water, a dilute aqueous sodium thiosulfate solution, water and finally with brine. The washed organic layer was then dried over MgSO₄, filtered, and concentrated to dryness. The crude compound was purified by flash chromatography over silica gel using a hexane to a 5% ethyl acetate/hexane gradient eluent to provide the vinyl-iodo compound (5b) as a colorless liquid (3.776 g, 74.24%).

¹H NMR (CDCl₃, 300 MHz): 6.54 (1H, m), 6.04 (1H, d), 3.64 (2H, t, J=6.44 Hz), 2.25 (2H, m), 0.88 (9H, s), 0.047 (6H, s).

¹³C NMR (CDCl₃, 300 MHz): 143 25(d), 76.35(d), 61.6(t), 39.34(t), 25.88(q), 18.25(s), −5.29(q).

HRMS: calculated: (M-C₄H₉)=254.9702, found: 254.9706.

LRMS: 255 (M-C₄H₉=base peak).

### Example 2

### General Procedure for Solid Phase Suzuki Coupling of the Boronate Ester to 4-bromopolystyrene

To an oven dried round bottomed flask was added 4-bromopolystyrene (1 molar equivalent) in anhydrous CH₂Cl₂ (10-50 ml). The mixture was stirred under an argon atmosphere for 10-15 minutes to allow for swelling of resin. Dichloro[1,1-bis(diphenylphosphino)ferrocene] palladium (II) dichloromethane adduct (0.05 to 0.1 equiv. or 5-10 molar %) catalyst was then added and the reaction mixture was stirred at room temp for an additional 15 minutes. Pinacolboronate ester (5-10 equiv.) in dry CH₂Cl₂ (15 ml) was then added followed by the addition of anhydrous CsF. The reaction mixture was then stirred at room temperature for 30-40 hours. The resin was filtered out, washed with CH₂Cl₂, H₂O, DMF, H₂O, THF, MeOH, CH₂Cl₂/MeOH, MeOH (20-40 ml of each solvent). The resin was subsequently dried under high vacuum for 3-6 hours to yield resin 1.

### Example 3

### General Procedure for Solid Phase Synthesis of Alcohol 8 and Aldehyde 10 Using Resin 1

a) Formation of Resin Bound Alcohol 6

To a stirred solution of vinyliodo compound 5b (3-5 equiv.) in dry ether (25 ml) was slowly added tert-butyllithium (6-10 equiv.) over a period of 15-20 minutes at −78° C. while under an argon atmosphere. The reaction mixture was then stirred at −78° C. for a period of 90 minutes, followed by 45 minutes at room temperature. The reaction mixture was then cooled to −78° C. and canulated to a pre-cooled mixture of resin 1 (1 equiv.) in dry THF (20-30 ml). The reaction mixture was allowed to slowly warm to room temperature and was subsequently stirred for an additional period of 15-20 hours. The solvent was decanted out and the MicroKan washed with THF, THF/H₂O(1:1), H₂O, THF, THF/CH₂Cl₂(1:1), CH₂Cl₂, MeOH (20-40 ml of each×3-5 min stirring). The MicroKan was dried under high vacuum for 3-6 hours to yield alcohol intermediate 6.

b) Formation of Resin Bound Carbonate

To an oven dried round bottomed flask was added 6 (1 equiv.) in dry THF (25-50 ml). The mixture was stirred at room temperature for 10-15 minutes while under an argon atmosphere allowing for swelling of the resin. n-Butyllithium (5 equiv.) was slowly added at −78° C. over a period of 5-10 minutes, followed by stirring the reaction mixture at the same temperature for an additional 2 hours. Methylchloroformate (7 equiv.) was added to the reaction mixture at −78° C. The reaction mixture was allowed to slowly warm to room temperature and was subsequently stirred for an additional period of 15-20 hours. The solvent was decanted out and the MicroKan washed with THF, THF/H₂O(1:1), H₂O, THF, THF/CH₂Cl₂(1:1), CH₂Cl₂, MeOH (20-40 ml of each×3-5 min stirring). The MicroKan was dried under high vacuum for 3-6 hours to yield the corresponding carbonate.

c) Formation of Resin Bound Alkene 7

To a stirred solution of anhydrous LiI (5 equiv.) and CuI (5 equiv.) in dry THF (50-100 ml), was slowly added an alkyl or aryllithium (10 equiv.) over a period of 15-20 minutes at −65° C. while under an argon atmosphere. The reaction mixture was then stirred at −65 to −30° C. for an additional 2-3 hours. It was subsequently cooled to −65° C., and the previously prepared carbonate 23 was added. The reaction mixture was allowed to slowly warm to room temperature and was subsequently stirred for an additional period of 15-20 hours. The solvent was decanted out and the resin was washed with NH₄Cl/NH₄OH (9:1), H₂O, THF/H₂O(1:1), THF, THF/CH₂Cl₂(1:1), CH₂Cl₂, MeOH (25-50 ml of each×3-5 min stirring). The resin MicroKan was dried under high vacuum for 3-6 hours to yield the cuprate addition compound 7.

d) Ozonolysis of resin bound alkene 7; liberation of alcohol 8

The resin-bound alkene 7 was taken-up in dry CH₂Cl₂ (20-40 ml) and stirred at room temperature for 10 minutes to allow for swelling of the resin. Ozone gas was bubbled through the chilled (−78° C.) mixture for 3-5 minutes, and the blue solution was stirred for an additional minute. Nitrogen gas was then bubbled through the reaction mixture over a period of 3-5 minutes in order to remove excess ozone (indicated by the solution becoming colorless). The reaction mixture was then diluted with dry MeOH (10-20 mL) and NaBH₄ (5 equiv.) was added at −78° C. The reaction mixture was allowed to slowly warm to room temperature and was subsequently stirred for an additional period of 15-20 hours. The solvent was decanted and the MicroKan was washed with CH₂Cl₂ and MeOH (20-40 ml each). The organic layers were combined and concentrated under vacuum. The concentrated organic layer was then poured into water and extracted with diethyl ether. The combined ether layers were washed with water and brine, dried over MgSO₄, filtered and concentrated. Drying under high vacuum over a 3-6 hour period provided crude alcohol 8 in yields ranging from 7-19% respectively (overall yield).

e) Ozonolysis of Resin Bound Alkene 24; Liberation of Aldehyde 10

The resin-bound alkene 7 was taken in dry CH₂Cl₂ (20-40 ml) and stirred at room temperature for 10 minutes to allow for swelling of the resin. Ozone gas was bubbled through the chilled (−78° C.) for 3-5 minutes, and the blue solution was stirred for an additional minute. Nitrogen gas was then bubbled through the reaction mixture over a period of 3-5 minutes in order to remove excess ozone (indicated by the solution becoming colorless). Dimethyl sulfide (10-20 equiv.) was added at −78° C. The reaction mixture was allowed to slowly warm to room temperature and was subsequently stirred for an additional period of 15-20 hours. The solvent was decanted and the MicroKan was washed with CH₂Cl₂ and MeOH (20-40 ml each). The organic layers were combined and concentrated under vacuum. The concentrated organic layer was then poured into water and extracted with diethyl ether. The combined ether layers were washed with water and brine, dried over MgSO₄, filtered and concentrated. Drying under high vacuum over a 3-6 hour period provided crude aldehyde 10 in yields ranging from 8-15% yields respectively (overall yield).

Although the present invention has been described hereinabove by way of preferred embodiments thereof, it can be modified without departing from the spirit and nature of the subject invention as defined in the appended claims.

### References

The following references, to the extent that they provide exemplary procedural or other details supplementary to those set forth herein, are specifically incorporated herein by reference.
Allin and Shuttleworth, Tetrahedron Lett., 37:8023-8026, 1996.
Arya and Qin, Tetrahedron, 56:917-947, 2000.
Green and Wuts, In: Protective Groups in Organic Synthesis, 2nd Ed., John Wiley & Sons, Inc., NY, 1991.
Kawana and Emoto, Tetrahedron Lett., 48:4855-4858, 1972.
Merrifield, J. Am. Chem. Soc., 85:2149-2154, 1963.
Meyers et al., J. Am. Chem. Soc., 103:3081-3087, 1981.
Moon et al., Tetrahedron Lett., 35:8915-8918, 1994.
The Chemist's Companion: A handbook of Practical Data, Techniques and References, John Wiley & Sons Inc., NY, 1972.
Worster et al., Chem. Int. Ed., 18:221-222, 1979.

1. A chiral resin comprising the following formula: 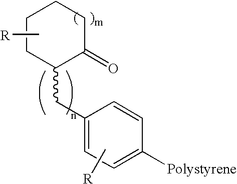
wherein R is selected from the group consisting of H, C1-C6 alkyl and C1-C6 branched alkyl; “n” represents an integer ranging from 1 to 3; and wherein “m” represents an integer ranging from 0 to 3.

2. The chiral resin of claim 1 comprising the formula:

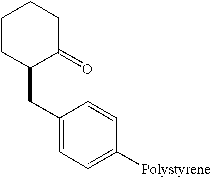

3. The chiral resin of claim 1 comprising the formula:

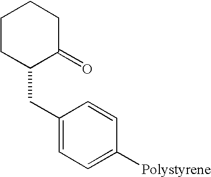

4. A method for the synthesis of chiral compound libraries comprising:
(a) reacting a vinyl iodide of formula: 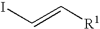
with a chiral resin of claim 1 to provide an allylic alcohol comprising the formula: 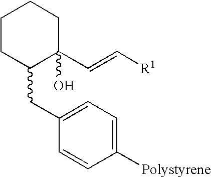
wherein R1 is selected from the group consisting of hydrogen, C1-C6 alkyl, C2-C6 alkenyl, C2-C6 alkynyl, C3-C6 cycloalkyl, alkylaryl, and alkyl silyl ether,
(b) transforming the allylic alcohol into an alkene comprising the formula: 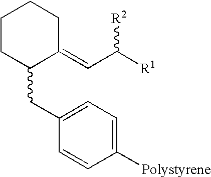
and
(c) oxidizing the alkene.

5. The method of claim 4, wherein transforming the allylic alcohol into an alkene comprises reacting the allylic alcohol with an organocuprate of formula (R2)2CuLi, wherein R2 is selected from the group consisting of C1-C6 alkyl, branched C1-C6 alkyl, and phenyl.

6. The method of claim 4, wherein said oxidizing generates a primary alcohol comprising the formula: 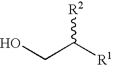
wherein R1 and R2 are as previously defined.

7. The method of claim 4, wherein said oxidizing generates an aldehyde comprising the formula: 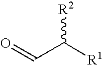
wherein R1 and R2 are as previously defined.

8. The method of claim 4, wherein said oxidizing generates an acid comprising the formula: 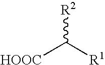
wherein R1 and R2 are as previously defined.
